(19) United States
(12) Patent Application Publication
(10) Pub. No.: US 2012/0254053 A1
(43) Pub. Date: Oct. 4, 2012

(54) On Demand Information Network

(75) Inventors: David Joa, San Bruno, CA (US); Thomas Wade Mann, Charlotte, NC (US); Robert Mark Jensen, Frisco, TX (US); Kent E. Wenger, Royersford, PA (US); Debashis Ghosh, Charlotte, NC (US)

(73) Assignee: Bank of America Legal Deparment, Charlotte, NC (US)

(21) Appl. No.: 13/076,037

(22) Filed: Mar. 30, 2011

(51) Int. Cl. G06Q 99/00; G06F 17/30

(52) U.S. Cl. 705/319; 707/732; 707/E17.059

(57) ABSTRACT

A computer system provides a unified view of data for different organizations of a business. The accessed data may be distributed over different data sources that may include a data warehouse, operational databases (e.g., systems of records supporting different functions), production servers, and external data sources. Access to one or more of the data sources may be restricted based on a user profile. Data may also be accessed by directly tapping into the systems of record of a business to potentially reduce the duplication of data and provide the data in a timelier basis. Data may be obtained from the systems of record by pinging selected systems using an application programming interface and may be stored in a computing cloud that is not constrained to a particular physical asset of the business. In addition, the accessed data may be analyzed and presented differently based on the different lines of business.

### FIELD

Aspects of the embodiments relate to a computer system that assesses different data sources in order to consolidate data. The consolidated data may be further analyzed to generate reports for a business goal, e.g., a marketing program.

### BACKGROUND

An employee of a business (e.g., financial institution, manufacturer, service provider, educational institution, etc.) often must access data from different data sources in order to analyze the data and to create a report about customers, where the data sources may span different storage entities in the business. For example, a company may wish to analyze and report the effectiveness of a marketing campaign for a new product.

The accessed data may span different sources internal or external to the business. For example, a data warehouse may function as the main source of data, in which operational information is cleaned, transformed, cataloged, and made available for different employees. The data warehouse is typically a central database storing offloaded data, which may be further processed, by obtaining data from operational systems of a business on a scheduled basis. The data from the data warehouse may be then used for reporting. A data warehouse may support its functions in three layers: staging, integration, and access. Staging is used to store raw data for use by developers (analysis and support). The integration layer is used to integrate data and to have a level of abstraction from users. The access layer is for getting data out for users. Additional data may be accessed from other storage entities of a business that are not integrated with the data warehouse as well as third party systems.

### BRIEF SUMMARY

Aspects of the embodiments address one or more of the issues mentioned above by disclosing methods, computer readable media, and apparatuses that provide a unified view of data for different organizations of a business. The accessed data may be distributed over different data sources that may include a data warehouse, operational databases (sometimes supporting different functions), production servers, and external data sources (e.g., that may be supported by third party providers).

According to an aspect of the embodiments, a unified view of the data may be provided by tapping (e.g., directly tapping) into the systems of record of a business. The systems of record may include operational databases as well as production servers that operate off the business grid from the operations databases. The approach of having a unified view of data reduces the duplication of data and helps in providing the data on a timelier basis to different business groups. Access to a data source, such as a system of record, may be restricted based on a user profile.

According to another aspect of the embodiments, accessed data may be analyzed and presented differently based on the different lines of business even though the accessed data may be overlapping with data accessed by other users.

According to another aspect of the embodiments, the effectiveness of a marketing campaign may be determined. Data contained in one or more of the data sources may indicate whether a promotional offer has been sent, whether the customer has responded to and accepted the offer, and whether the customer has satisfied the conditions of the offer. The data may be further analyzed to determine the number of customers participating in the marketing campaign and a report may be generated for a user. In addition, the data may capture the on-going interaction with each of the customers.

With another aspect of the embodiments, different technical capabilities may be supported with respect to traditional systems. Common datasets may be provided that span multiple business groups (e.g., line of business) rather than maintaining disparate datasets that may be inconsistent and not synchronous in time. The data may be extracted, validated, transformed, and loaded into one or more common data sources. However, even though data may be shared with one or more data sources, data may be tailored for a particular business group.

With another aspect of the embodiments, data may be obtained directly from the systems of record without the data being extracted and transformed from the systems of record into the business data warehouse. A virtualization layer may aggregate the data directly from the systems of record and save the directly accessed data into a virtual memory such as in a computing cloud, thus reducing latency time associated with processing data to the business warehouse. The virtualization layer may directly assess the systems of record “on the fly” so that data is more current than with typical traditional systems.

With another aspect of the embodiments, different datasets may be created for different users and are not constrained to be stored at a physical asset such as the business warehouse. Data may be obtained from the systems of record by pinging selected systems using an application programming interface (API) and may be stored in the computing cloud that is not constrained to a particular physical asset.

With another aspect of the embodiments, a computer system determines a level of access from a profile of the user, selects designated data sources from a plurality of data sources based on the level of access, obtains a subset of the data from the designated data sources, creates a dataset for the user from the subset, and presents the dataset. The subset of data may be analyzed and reported in a presentation format based on the profile of the user.

With another aspect of the embodiments, a score may be determined based on a specified characteristics and/or attribute of a customer. The determined score may be used for a number of purposes. For example, a score may be indicative of the type of preferred communications channel for a customer, e.g., e-mail versus regular U.S. postal mail. When the score exceeds a predetermined threshold, a selected user action may be initiated.

Aspects of the embodiments may be provided in a computer-readable medium having computer-executable instructions to perform one or more of the process steps described herein.

These and other aspects of the embodiments are discussed in greater detail throughout this disclosure, including the accompanying drawings.

### BRIEF DESCRIPTION OF THE DRAWINGS

The present disclosure is illustrated by way of example and not limited in the accompanying figures in which like reference numerals indicate similar elements and in which:

FIG. 1 shows an illustrative operating environment in which various aspects of the disclosures may be implemented.

FIG. 2 is an illustrative block diagram of workstations and servers that may be used to implement the processes and functions of certain aspects of the present disclosure.

FIG. 3 shows a system that provides consolidated data obtained from different data sources and that supports reporting capabilities for the user in accordance with an aspect of the disclosure.

FIG. 4 shows a block diagram for the system shown in FIG. 3 in accordance with an aspect of the disclosure.

FIG. 5 shows a process for accessing data from different data sources based in a user profile in accordance with an aspect of the disclosure.

FIG. 6 shows a process for determining an action based on a determined score of accessed data in accordance with an aspect of the disclosure.

FIG. 7 shows an exemplary screenshot of a consumer marketing summary in accordance with an aspect of the disclosure.

FIG. 8 shows an exemplary screenshot in which a user drills down into the data that is summarized in FIG. 7 in accordance with an aspect of the disclosure.

FIG. 9 shows an exemplary screenshot for an executive report for data summarized in FIG. 7 in accordance with an aspect of the disclosure.

FIG. 10 shows an exemplary screenshot of a marketing segment dashboard for data summarized in FIG. 7 in accordance with an aspect of the disclosure.

FIG. 11 shows an exemplary screen shot for configuring the notification to a user when a score from accessed data exceeds a predetermined threshold in accordance with an aspect of the disclosure.

FIG. 12 shows an exemplary screenshot of a customized dashboard in accordance with an aspect of the disclosure.

### DETAILED DESCRIPTION

In the following description of the various embodiments, reference is made to the accompanying drawings, which form a part hereof, and in which is shown by way of illustration various embodiments in which the disclosure may be practiced. It is to be understood that other embodiments may be utilized and structural and functional modifications may be made without departing from the scope and spirit of the present disclosure.

In the description herein, the following term is referenced.

### System of Record:

A system of record (SOR) includes an information storage system (commonly implemented on a computer system), which is the authoritative data source for a given data element or piece of information. A system record may refer to data elements that are generated from customer-facing activities and production-level processes.

In accordance with various aspects of the disclosure, methods, computer-readable media, and apparatuses are disclosed for providing a unified view of data for different organizations of a business. For example, for a financial institution, overlapping and non-overlapping data may be accessed to analyze checking, credit card, and/or home loan customers. The data may be distributed over different data sources that may include a data warehouse, operational databases (often supporting different functions), production servers, external data sources (e.g., that may be supported by third party providers), and domain servers that reside in line of business (LOB) domains such as call centers and mobile banking.

According to an aspect of the embodiments, a unified view of the data may be provided by directly tapping into the systems of record of a business. The systems of record may include operational databases as well as production servers that operate off the business grid from the operations databases. The approach of having a unified view of data may reduce the duplication of data and help in providing the data in a timelier basis to the different business groups. However, according to another aspect of the embodiments, access to a data source may be restricted based on a user profile. For example, a record of a customer transaction with a teller that is stored on a banking production server may not be accessible by certain business groups because of privacy and security reasons. Consequently, data sources for the data may be selected based on the user profile, which may identify a user's business group.

According to another aspect of the embodiments, accessed data may be analyzed and presented differently based on the different lines of business even though the accessed data may be overlapping with data accessed by other users.

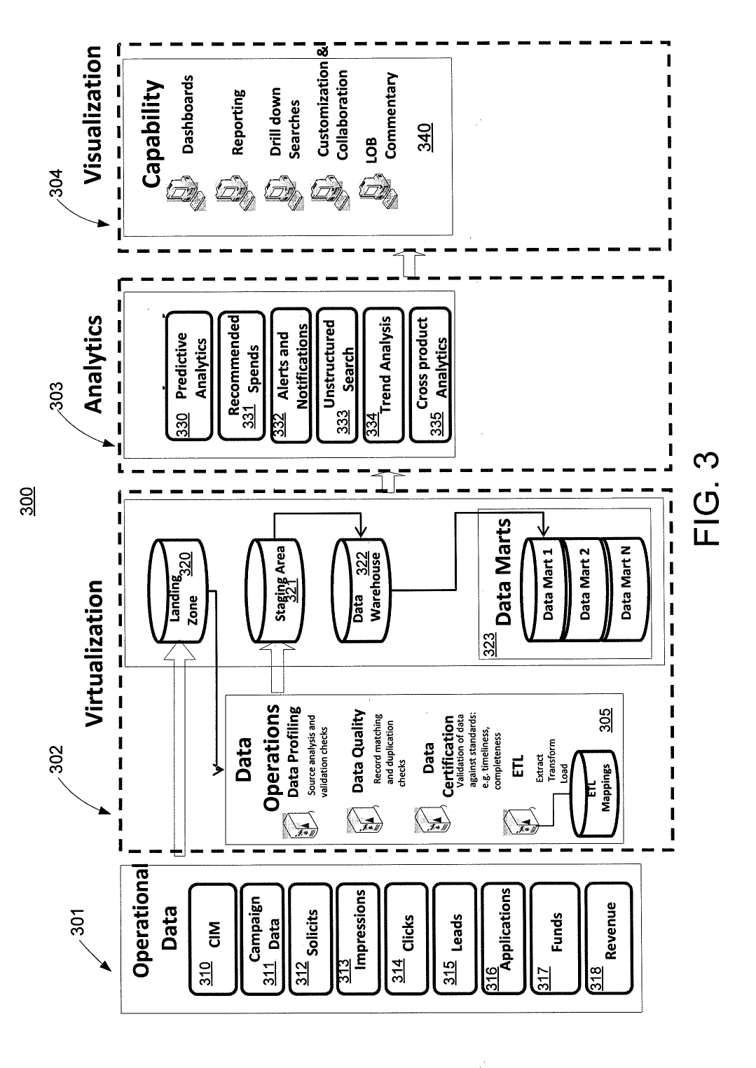

According to another aspect of the embodiments, the effectiveness of a marketing campaign may be determined, for example, by analyzing a subset of data. In one example, a bank may offer (e.g., as part of a targeted marketing campaign) a checking account or a credit card without the usual fees if a customer maintains a minimum amount in a saving account. Some examples may utilize a virtualization layer (e.g., corresponding to virtualization sub-system 302 as shown in FIG. 3) to estimate revenue and profitability with reduced data migration latency. For instance, a credit card customer may use the card to pay for a mortgage application fee to a competitor. The competing mortgage offer may be approximated with an application programming interface (API) to price comparison sites (bank rate, for example) and to research the then-current offerings from competitor's websites and publicly posted rate sheets. The virtualization layer may calculate the amount of the customer profitability based on a series of factors, determine the approximate leverage ratio (between credit and net worth), and assign a discount factor to a mortgage product that may become available to the customer next time the customer visits a banking center or calls customer service or visits the online banking site. The reduction in time-to-market from the data discovery may minimize the likelihood of the customer acquiring a mortgage with a competitor if a perfectly acceptable substitution is offered to the customer during the next interaction opportunity.

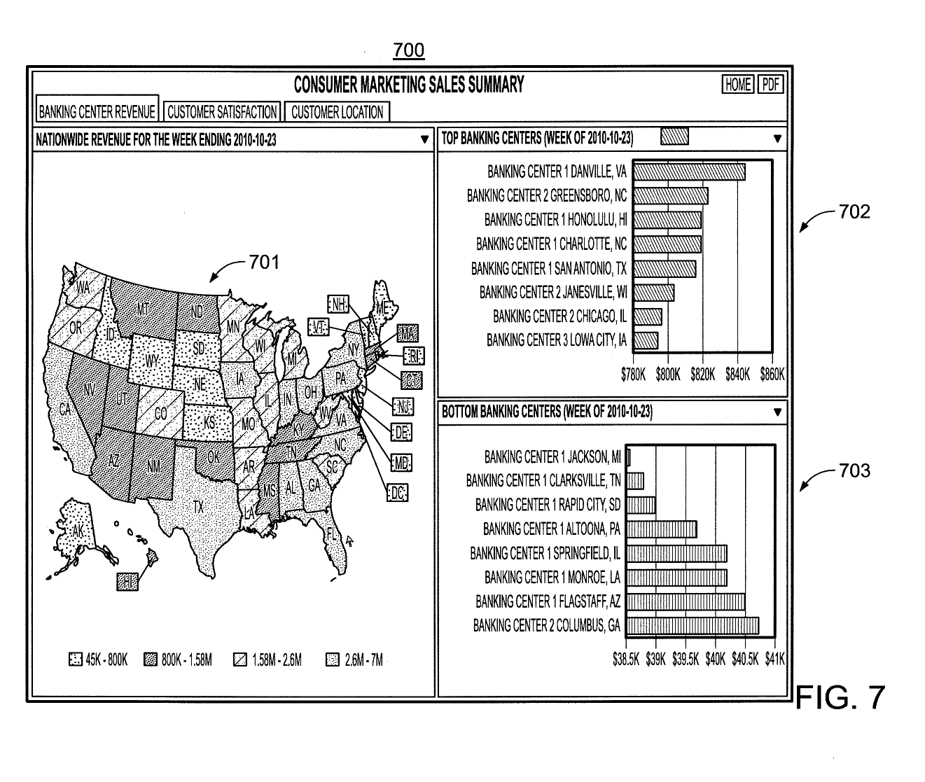

Data contained in one or more of the data sources may indicate whether a promotional offer has been sent, whether the customer has responded to and accepted the offer, and whether the customer has satisfied the conditions of the offer. The data may be further analyzed to determine the number of customers participating in the marketing campaign, and a report (e.g., as shown in FIGS. 7-12) may be generated for a user (e.g., manager). The effectiveness of marketing campaign may be determined by analyzing the aforementioned data. For example, if a high percentage of customers that were offered the promotion also accepted the offer, the marketing campaign may be considered more effective. In addition, data may capture the on-going interaction with each of the customers. For example, once a particular customer has met all the conditions for an offer, the business may record on a data source whether an incentive promised in the marketing campaign has been given to the customer. Also, data may be updated that the particular customer should not be sent the offer again.

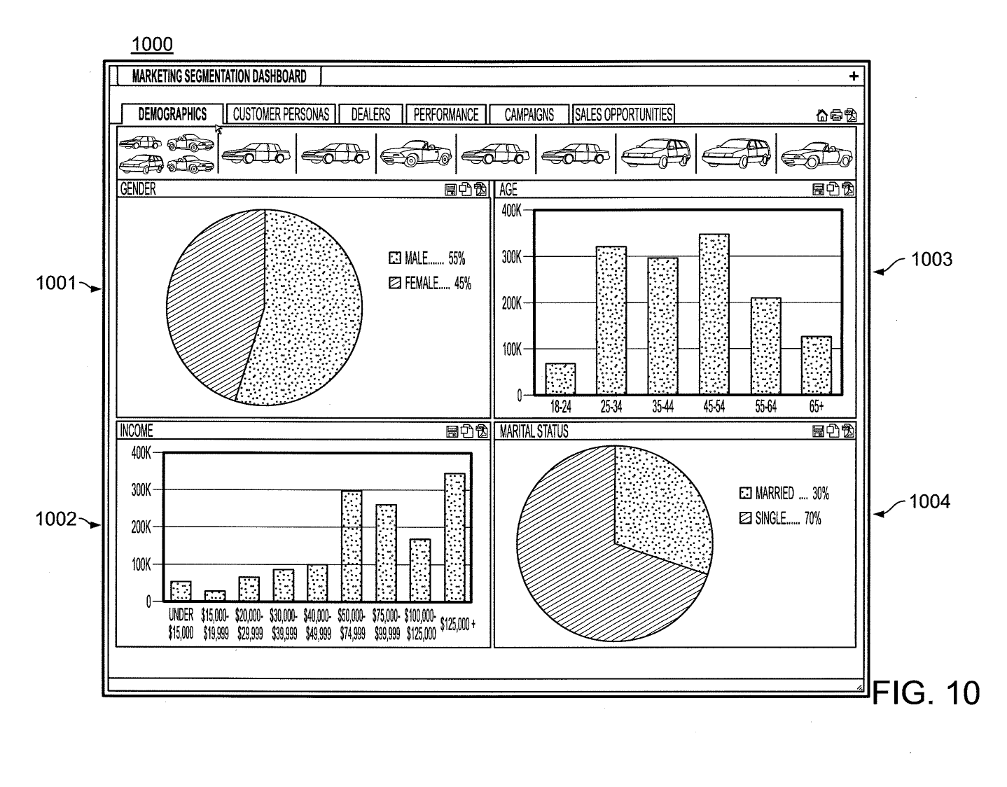

With another aspect of the embodiments, different technical capabilities may be supported with respect to traditional systems. Common datasets may be provided that span multiple business groups (e.g., line of business) rather than maintaining disparate datasets that may be inconsistent and not synchronous in time. The data may be extracted, validated, transformed, and loaded into one or more common data sources. However, even though data may be shared with one or more data sources, data may be tailored for a particular business group (e.g., mortgage versus credit card) as exemplified in FIGS. 7-9. Also, reports may be visualized as a dashboard graphical format as shown in FIG. 10.

With another aspect of the embodiments, data may be tapped directly from the system of records (SORs) without the need to store persistently in a data warehouse. The data may be further transformed according to business rules, verified, and made available with a virtualization layer. With some embodiments, the virtualization layer may accumulate the data from the SOR only for the duration of the user's request. The virtualization layer may aggregate the data directly from the systems of record (e.g., systems 310-318 as shown in FIG. 3) and save the directly accessed data into a virtual memory such as in a computing cloud, thus potentially reducing latency time associated with processing data to the business warehouse. With traditional systems, data may be periodically accessed and processed from the systems of record (for example, on a weekly or month basis) when updating data in a data repository. With an aspect of the embodiments, the virtualization layer directly assesses the systems of record “on the fly” so that data is more current than with typical traditional systems.

With another aspect of the embodiments, different datasets may be created for different users and are not constrained to be stored at a physical asset such as the business warehouse. For example, data may be obtained from the systems of record by pinging selected systems using an application programming interface (API) and may be stored in the computing cloud that is not constrained to a particular physical asset.

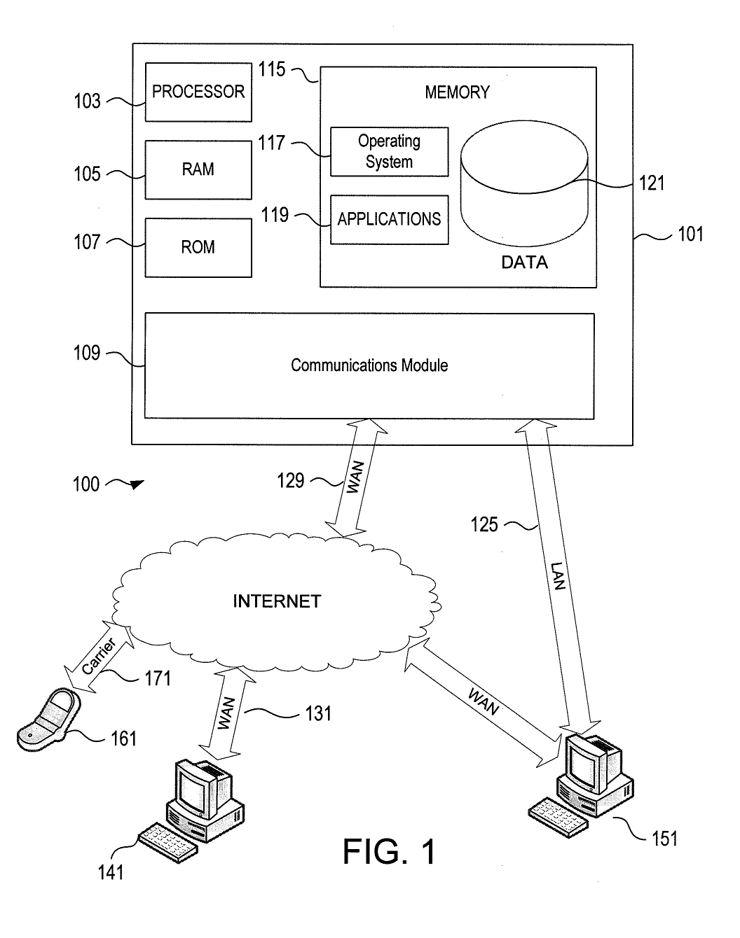

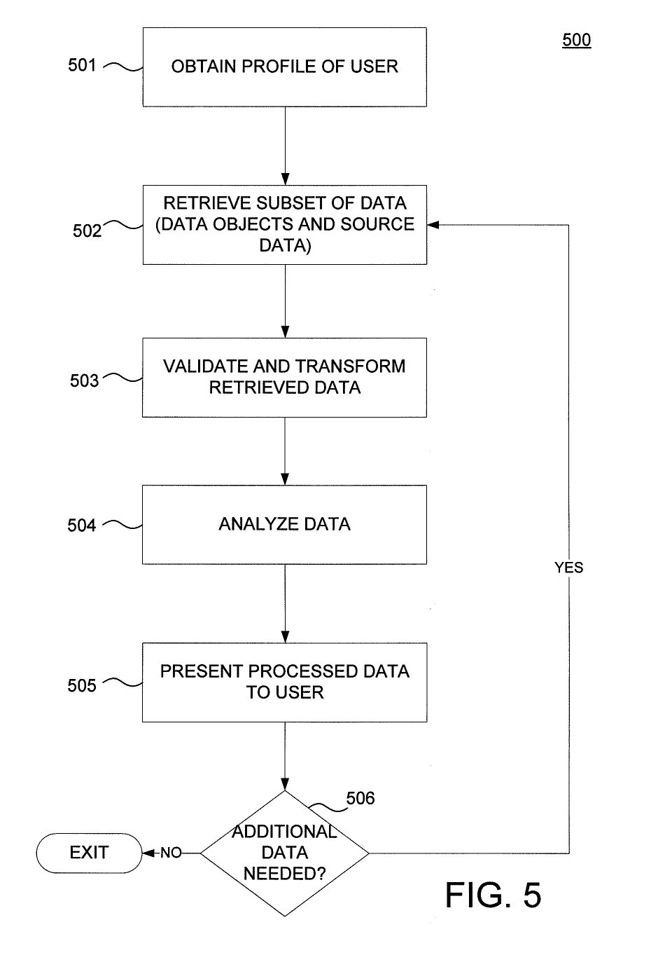

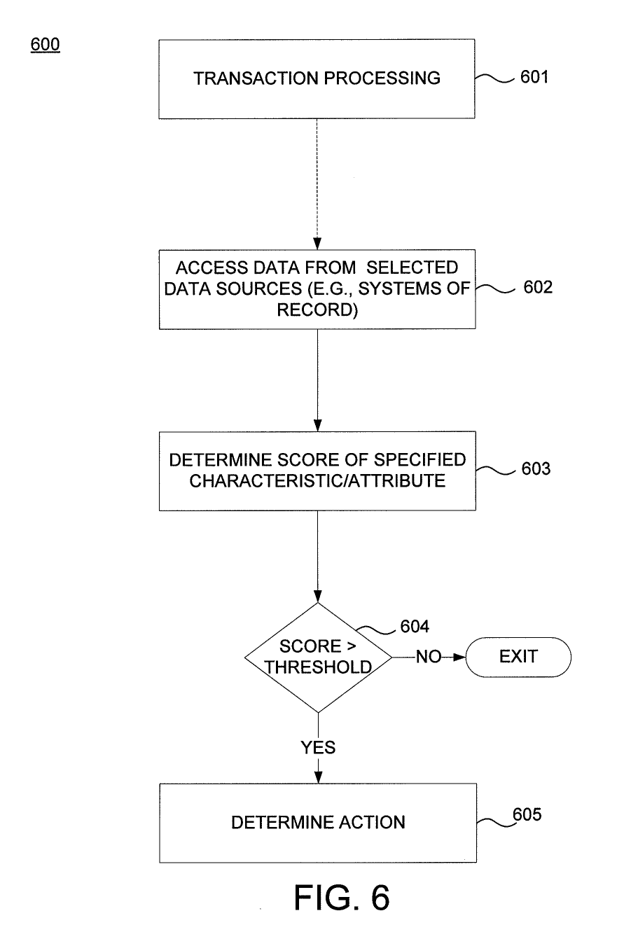

FIG. 1 illustrates an example of a suitable computing system environment 100 (e.g., for processes 500 and 600, as shown in FIGS. 5 and 6, respectively) that may be used according to one or more illustrative embodiments. The computing system environment 100 is only one example of a suitable computing environment and is not intended to suggest any limitation as to the scope of use or functionality contained in the disclosure. The computing system environment 100 should not be interpreted as having any dependency or requirement relating to any one or combination of components shown in the illustrative computing system environment 100.

The disclosure is operational with numerous other general purpose or special purpose computing system environments or configurations. Examples of well known computing systems, environments, and/or configurations that may be suitable for use with the disclosed embodiments include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

With reference to FIG. 1, the computing system environment 100 may include a computing device 101 wherein the processes discussed herein may be implemented. The computing device 101 may have a processor 103 for controlling overall operation of the computing device 101 and its associated components, including RAM 105, ROM 107, communications module 109, and memory 115. Computing device 101 typically includes a variety of computer readable media. Computer readable media may be any available media that may be accessed by computing device 101 and include both volatile and nonvolatile media, removable and non-removable media. By way of example, and not limitation, computer readable media may comprise a combination of computer storage media and communication media.

Computer storage media include volatile and nonvolatile, removable and non-removable media implemented in any method or technology for storage of information such as computer readable instructions, data structures, program modules or other data. Computer storage media include, but is not limited to, random access memory (RAM), read only memory (ROM), electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and that can be accessed by computing device 101.

Communication media typically embodies computer readable instructions, data structures, program modules or other data in a modulated data signal such as a carrier wave or other transport mechanism and includes any information delivery media. Modulated data signal includes a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Computing system environment 100 may also include optical scanners (not shown). Exemplary usages include scanning and converting paper documents, e.g., correspondence, receipts, etc. to digital files.

Although not shown, RAM 105 may include one or more are applications representing the application data stored in RAM memory 105 while the computing device is on and corresponding software applications (e.g., software tasks), are running on the computing device 101.

Communications module 109 may include a microphone, keypad, touch screen, and/or stylus through which a user of computing device 101 may provide input, and may also include one or more of a speaker for providing audio output and a video display device for providing textual, audiovisual and/or graphical output.

Software may be stored within memory 115 and/or storage to provide instructions to processor 103 for enabling computing device 101 to perform various functions. For example, memory 115 may store software used by the computing device 101, such as an operating system 117, application programs 119, and an associated database 121. Alternatively, some or all of the computer executable instructions for computing device 101 may be embodied in hardware or firmware (not shown). Database 121 may provide centralized storage of risk information including attributes about identified risks, characteristics about different risk frameworks, and controls for reducing risk levels that may be received from different points in system 100, e.g., computers 141 and 151 or from communication devices, e.g., communication device 161.

Computing device 101 may operate in a networked environment supporting connections to one or more remote computing devices, such as branch terminals 141 and 151. The branch computing devices 141 and 151 may be personal computing devices or servers that include many or all of the elements described above relative to the computing device 101. Branch computing device 161 may be a mobile device communicating over wireless carrier channel 171.

The network connections depicted in FIG. 1 include a local area network (LAN) 125 and a wide area network (WAN) 129, but may also include other networks. When used in a LAN networking environment, computing device 101 may be connected to the LAN 825 through a network interface or adapter in the communications module 109. When used in a WAN networking environment, the server 101 may include a modem in the communications module 109 or other means for establishing communications over the WAN 129, such as the Internet 131. It will be appreciated that the network connections shown are illustrative and other means of establishing a communications link between the computing devices may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages. The network connections may also provide connectivity to a CCTV or image/iris capturing device.

Additionally, one or more application programs 119 used by the computing device 101, according to an illustrative embodiment, may include computer executable instructions for invoking user functionality related to communication including, for example, email, short message service (SMS), and voice input and speech recognition applications.

Embodiments of the disclosure may include forms of computer-readable media. Computer-readable media include any available media that can be accessed by a computing device 101. Computer-readable media may comprise storage media and communication media. Storage media include volatile and nonvolatile, removable and non-removable media implemented in any method or technology for storage of information such as computer-readable instructions, object code, data structures, program modules, or other data. Communication media include any information delivery media and typically embody data in a modulated data signal such as a carrier wave or other transport mechanism.

Although not required, various aspects described herein may be embodied as a method, a data processing system, or as a computer-readable medium storing computer-executable instructions. For example, a computer-readable medium storing instructions to cause a processor to perform steps of a method in accordance with aspects of the disclosed embodiments is contemplated. For example, aspects of the method steps disclosed herein may be executed on a processor on a computing device 101. Such a processor may execute computer-executable instructions stored on a computer-readable medium.

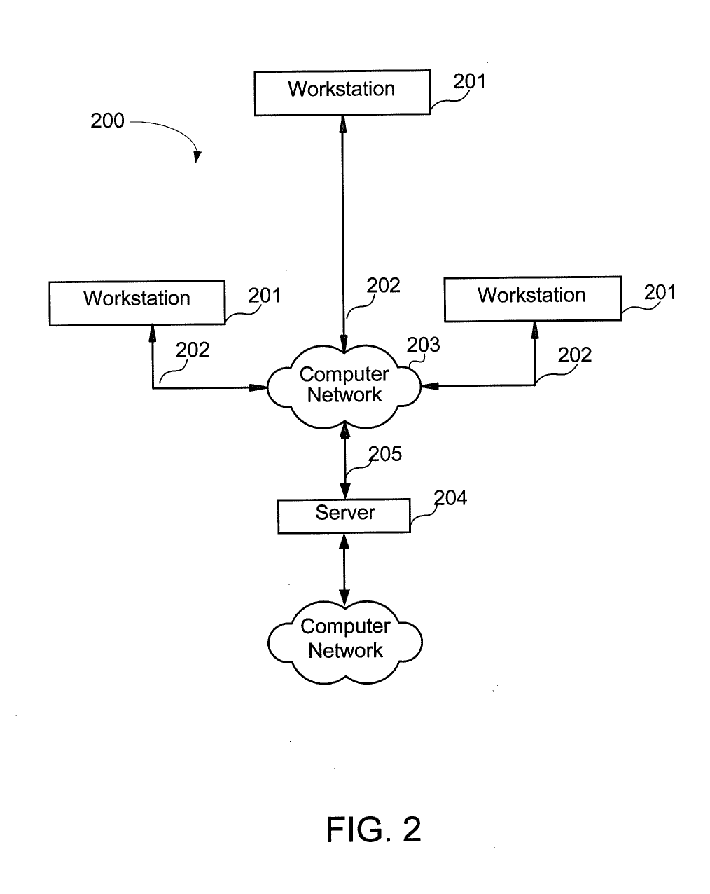

Referring to FIG. 2, an illustrative system 200 for implementing methods according to the present disclosure is shown. As illustrated, system 200 may include one or more workstations 201. Workstations 201 may be local or remote, and are connected by one of communications links 202 to computer network 203 that is linked via communications links 205 to server 204. In system 200, server 204 may be any suitable server, processor, computer, or data processing device, or combination of the same. Server 204 may be used to process the instructions received from, and the transactions entered into by, one or more participants.

Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201 and server 204, such as network links, dial-up links, wireless links, hard-wired links, etc. Connectivity may also be supported to a CCTV or image/iris capturing device.

The steps that follow in the Figures may be implemented by one or more of the components in FIGS. 1 and 2 and/or other components, including other computing devices.

With traditional systems, there may be a lack of positive impact on business operations despite the plethora of data, data warehouses and business intelligence software within the business. Business users may be frustrated by inaccurate and incomplete data. Decisions may be made on limited data. Also, many operational inefficiencies may exist and operational data may be underutilized. Moreover, there may be limited visualization and an inability to drill down into underlying report details. With traditional systems there may be multiple reporting formats, conflicting definitions in reports, and inconsistent reporting process, metrics and timeline across channels. Also, there may be no common performance reporting across channels, limited information by segment and by channel, inadequate linkage and tracking between offer and sale, and potential double counting. With traditional systems there may be a time delay between test execution and analytics implementation and limited availability of real data. Also, there may be a variety of disconnected reporting assets used across the business.

FIG. 3 shows system 300 that provides consolidated data obtained from different data sources and that supports reporting capabilities for the user in accordance with various aspects of the disclosed embodiments. As will be further discussed, data sources may include systems of record, data warehouses, data marts, and third-party information systems.

System 300 may track the performance of all direct marketing programs and customer contact points. The performance tracking may include customer contacts, marketing responses, units, cost, performance, and share value added (SVA). The measure of performance may be compared to the forecasted and planned levels, and the statistical significance and incremental impact of marketing campaigns may determined. System 300 may also report on the performance of indirect marketing programs. Calculated and/or estimated values may include predictive scores (e.g., propensity to attrite, likelihood to purchase, and the like). These are examples of additional data elements that may be blended into the virtualization layer.

System 300 may present processed data from the data sources by creating an automated dashboard and key performance indicator (KPI) reporting platform. Also, the consolidated direct marketing impact may be determined across all products, segments, and channels. System 300 may also provide aggregated portfolio metrics (which may be referred as scores) and proactive alerts and warnings as will be discussed.

System 300 may adhere to corporate data standards and a single definition of truth. For example, a single definition of truth may refer to rules that are applied consistently to a SOR. For example, a checking account transaction should have the same value and definition when two different data groups extract the record from the SOR. The value and definition may vary depending on different factors (for example, time of extraction, business line extracting the record, location of the customer who performed the transaction, and the like). In another context, the single definition of the truth may refer to the results of analyses produced by different analysts. Analysis conclusions may differ based on which data rules/business rules were applied during the analysis, the techniques used to analyze the data, variance in the interpretation of business events, and the like.

System 300 may support customer level reporting and cross marketing campaign analysis. Populations for the reporting may be defined by criteria, lead files, and trigger events. Also, system 300 may track and analyze sequenced marketing offers.

System 300 may also support enhanced reporting capabilities relative to traditional systems. For example, system 300 may consolidate multiple platforms into one single solution and provide drill down capabilities in all standard reports. Dimensions may include segment, product, marketing campaigns, test cell, risk scores, relationship, and other pre-defined segments. Segments may be created based on multiple dimensions (e.g., age, demographic values, share-of-wallet values, and the like). For example, a financial institution may have publicly identified four segments: large corporations, high net worth individuals/mass affluents, mass markets, and small businesses. However, the definitions of segments may vary for different financial institutions. A financial instiution may determine how to service each customer by assigning a segment definition to each customer. Hence, products, services, marketing communications, and the like may be tailored to address the perceived needs of the defined segments. System 300 may provide customized and ad-hoc reports and facilities creation, saving, sharing the reports between users in the business, and comparisons to financial forecasts and plans. Reports may incorporate transaction data from operational data 301 as well as on-line performance data. For example, a report may span all customers who own and/or use a specific product or combination of products. System 300 may consequently provide improved periodicity of reporting relative to traditional systems.

With some embodiments, a marketing program/campaign may be created based on the need to identify customers with specific qualities. Targeting intones selectively choosing customers with attributes that will increase likelihood of the customer responding to the marketing stimulation (e.g., an incentive, discounted products and fees, and the like).

With some embodiments, test cells in a marketing campaign are singled out based on the criteria used to create a discriminate group (the target), where the test cells receive a treatment (the marketing stimulation). The results of this marketing treatment on the test cells may be compared to a control cell (the null hypothesis) to calculate an incremental lift.

With some embodiments, risk scores are derived statistical values associated with a defined population or cohort. The score may be a calculated probability the customer will respond to the event/offer. The event may be likelihood to purchase a product, likelihood to default, etc.

With some embodiments, system 200 may be independent of the data infrastructure. Consequently, system 300 may leverage data from multiple data sources and has the ability to grow and to accommodate new infrastructures.

Systems of records may include different information storage entities storing one or more operational datasets 310-318, where each system of record includes the data source for a given data element. For example, each time a bank customer visits a bank teller, the transaction information may be maintained in one of the operational datasets.

Operational data 301 may be further processed by virtualization sub-system 302, which may directly tap into the systems of record through landing zone 320 and/or staging area 321. Operational data 301 may be further processed by analytics sub-system 303 and presented to a user by visualization sub-system 304. Consequently, updated operational data may be accessed at a particular time as requested by a user by creating a virtual dataset based on the user profile as will be further discussed in FIG. 5. For example, the virtual dataset may be available, in some embodiments, to those users on a computing cloud that are not restricted to a particular physical asset of the business.

With some of the embodiments, sub-systems 302, 303, and 304 may execute on the same or different computing platforms that are shown in FIGS. 1 and 2.

With some embodiments, operational data 301 may be processed by data operations 305 to validate, check for duplication, certify, extract, transform, and load the processed data. The processed data may be stored into data warehouse 322 for subsequent access by a user in the business. Data marts 323 may store data collected by an individual line of business and may be isolated from the system of records. For example, a credit card call center may capture calls (for example, in a digital format) for customers calling an 800 number. Data marts 323 may comprise a list of customers who were identified by the line-of-business analysts to be mass affluent. This pre-defined list of customers may be linked to data warehouse 322 based on an analyst's log-in credentials (which determines access level to the data in data warehouse 322, including the permissible data elements in data warehouse 322). From the list for data marts 323, the analyst may be able to extract variables from data warehouse 322 that may help generate a defined set of reports (for example, assets under management (AUM), customers who are homeowners, households with children, number of calls in the last month, and the like). Data marts 323 may also comprise a list of regional banking center managers. At the operational level, the list may represent an operations research list that may help the business determine the most desirable geography to open a new banking center. Data marts 323 may comprise a list that includes proximity of customers in the geographic region to the nearest banking center sorted by distance. For example, the list of customers may be linked to data warehouse 322 to extract analysis variables to determine profitability (amount of deposits, cost of servicing the accounts, and the like). The resulting analysis may help determine the potential overlap between banking centers and impact to deposit/credit market share for a new region.

Analytics sub-system 303 may analyze data from virtualization subsystem 302 by supporting analysis capabilities that include predictive analysis 330, recommended spends 331, alerts and notifications 332, unsearched search 333, trend analysis 334, and cross product analytics 335. Analysis sub-system 303 may comprise a modular analysis component layer, in which each building block in the layer may inter-operate within the layer. The list of customers 323 may also be linked to individual analysis components in 303. For example, list of customers 323 may be linked to the types of channels customers used for a specific duration (e.g., 3 months or 5 months). The channel analysis component (not explicitly shown in FIG. 3) may create a frequency distribution by month for each channel (telephone, ATM, banking center, web, mobile, etc.). Similarly, by linking list 323 to trend analysis 334, a corresponding suite of trending charts may track different attributes of interest (payments to specific merchant types, income, etc.).

With some embodiments, analytics sub-system 303 may analyze some of the extracted data in the context of other data in order to support the self-healing of data. For example, the type of customer transaction at a banking location may be ambiguous or overly broad. By analyzing the transaction in the context of previous customer transactions or with respect to the frequency of different transaction types at the particular bank location, analytics sub-system 303 may be able to narrow the transaction type. As an example, a transaction business transaction may be broadly categorized as OTHER, while further analysis indicates that the customer often requests foreign drafts at the banking location. In such a case, analytics sub-system may narrow the transaction category to FOREIGN DRAFT.

The analyzed data from analytics subsystem 303 may then be presented to a user by visualization subsystem 304 as exemplified by the screenshots in FIGS. 7-12. With some embodiments, visualization subsystem 304 supports presentation capabilities 340 including dashboards, reporting, drill down searches, customization collaboration, and line of business (LOB) commentary. LoB commentary may include the capability by the business user to annotate visualization output. For example, the output may include a bar chart with numeric values associated with each bar. The LoB commentary may embed within the bars, commentary related to the numeric value, and the LoB commentary may also be in the form of a pop-up window that includes annotated visual images of an ad that may be used to coincide with the results being displayed.

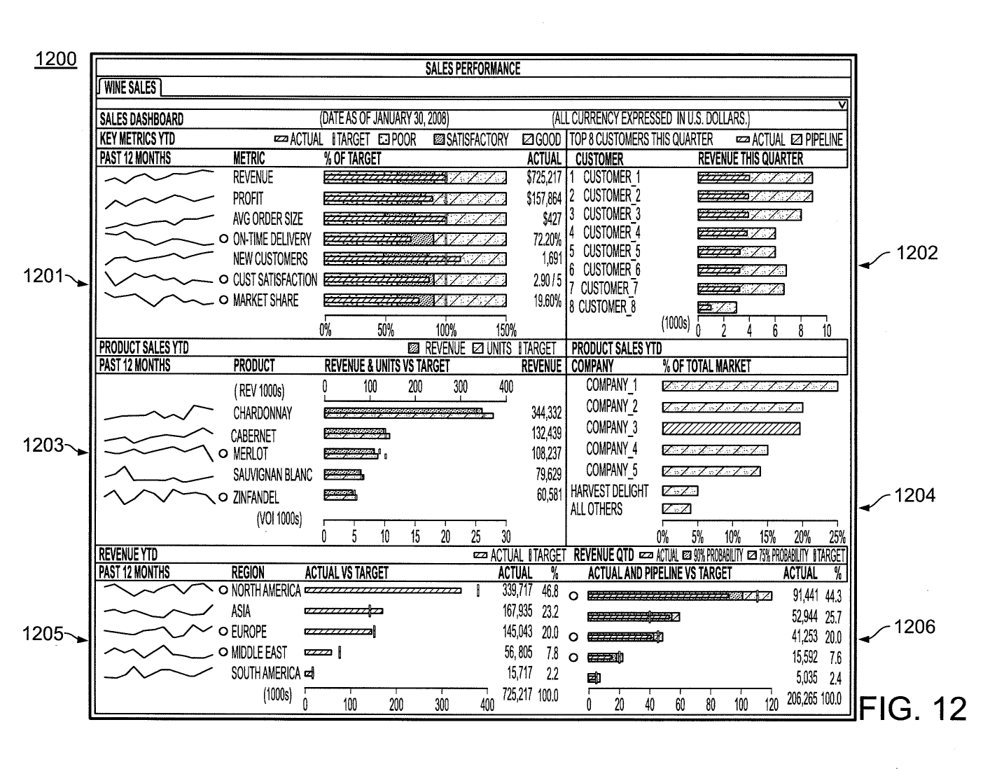

With some embodiments, visualization subsystem 304 provides an ability to re-use templates, trigger-based reporting, collaborative creation, and the use of new templates. For example, a presentation of a dashboard (e.g., as shown in FIGS. 10 and 12) enables a user to view templates, reports, and alerts and to personalize the dashboard. The user may search for existing templates, create new templates, and save templates to a library for later use. Also, a user may view or preview exiting reports, generate reports using a wizard, schedule and distribute reports, generate trend reporting, and generate analytics reports (e.g., spend recommendations). Visualization subsystem 304 may support reporting capabilities using analytical customer models (e.g., Common Information Model (CIM)) based on relationship, growth, and interactions.

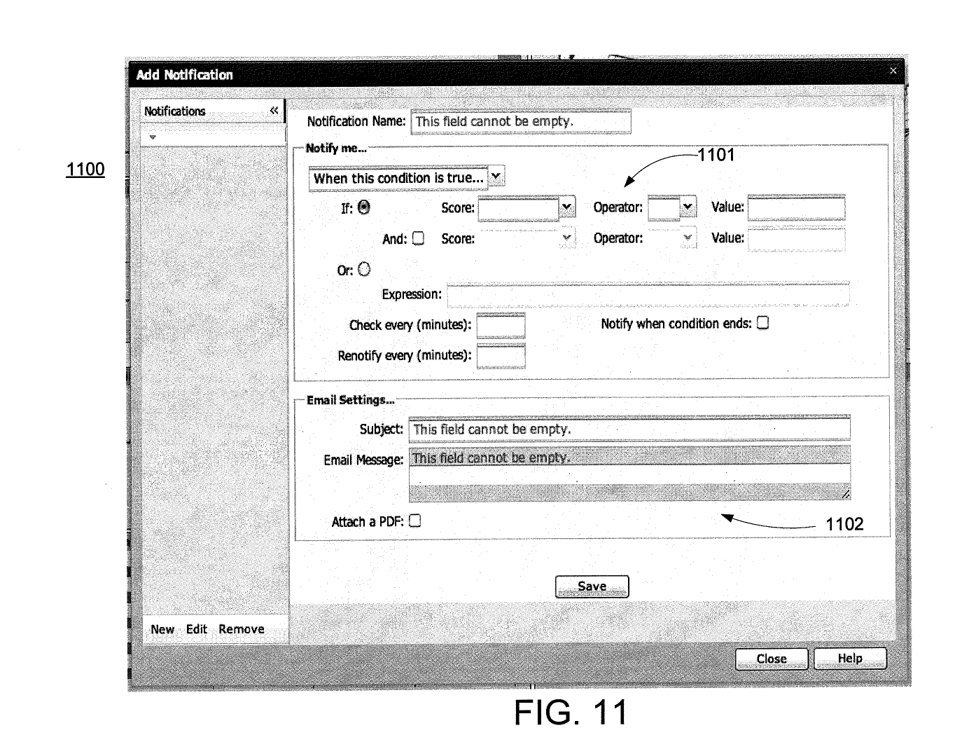

Visualization subsystem 304 may also generate alerts based on financial and relationship events, e.g., based a score of a specified characteristic/attribute exceeding a predetermined threshold as shown in FIG. 6. A user may configure a notification based on a score and a communication channel for notifying the user, e.g., as shown in Figure 11. Also, a user may be notified upon the completion of reports or upon the availability of data. Common services may share reports and templates, audit trails and metrics, access controls, and systematically archive reports.

With some embodiments, visualization subsystem 304 may also support collaboration and customization by supporting co-creating and annotating reports and templates with other users. Reports may be custom styled and formatted, e.g., with a commentary capability for a business group. Also, workflows may be globally shared within the business group as well as with other business groups.

With some embodiments, visualization subsystem 304 may support a search capability that enables a user drill down into reporting components, e.g., charts, graphs, summary data, and data sources to get the underlying details meta data and XML tag searches.

With some embodiments, visualization subsystem 304 may provide cross product marketing support cross product analytics, household profiling, and predictive cross product marketing.

With some embodiments, system 300 may be implemented in a staged approach. With traditional systems, reporting capabilities may be limited due to disparity in technical assets, and a lack of consistency in process, definitions, metrics and formats. Reports may be created in various formats with minimal flexibility to customize. Because of the redundant and disparate reporting assets, traditional systems are often not conducive to the sharing of knowledge among different groups in a business.

According to some embodiments, stage 1 selects reports that can be tailored per client needs. Stage 1 focuses on ensuring aggregated information is accurate and available per service level agreement (SLA). Also, sharing is provided by the creation of standard templates. With stage 2, reports are flexible within boundaries. Stage 2 focuses on tailored on demand aggregated information with ability to drill down into the details. Different business groups may share best practices and use workflows to optimize operations. Also, stage 2 may support linkages between transactions (e.g., offer versus sale) and embedded data mining capabilities in the reporting process. With stage 3 reports may support multiple delivery channels, e.g., online, handheld, and wikis. Stage 3 focuses on providing any requested data, report, and format at any requested any time (e.g., daily reporting). Consequently, stage 3 may support a platform that enables cross product marketing. With some embodiments, cross product marketing refers to the capability to house a large and disparate set of data at the virtualization layer to enable the calculations of very complex probabilities in order to determine likelihoods beyond next logical products. For example, if list 323 for mass affluents were loaded as a data request, the virtualization layer may extract all data permitted to the user for review. The data may include transactions of different bank credit products, inflow of funds, merchant level data, etc. The cross product marketing end product may include a series of marketing messages and promotional offerings tailored to the mass affluent customer. The promotional messages may include discounted offers to merchants within the vicinity of the customers' residences, e-mail listing available homes for sale from the bank's distressed assets group, etc.

With another aspect of the embodiments, a data governance framework may be provided for the introduction of new data sources and on-going data certification and management. Policies and standards may help ratify and support policies, ratify metrics for customer quality, define, document and execute policies, define data quality metrics, leverage policies for project compliance, and adopt data metrics. An associated process may rule on escalations for data management decisions, provide a forum for data issue resolution, include data quality processes, data management processes, create metadata, create a taxonomy, and provide governance for project execution.

Consequently, the data governance framework may enable a business organization to explore if existing data can be used for other purposes, improve the ability to search data by tagging it with keywords, descriptions, or assigning it to a category, provide metrics on data consistency, assess risks for integrating new data sources, and access whether metadata accurately describes the actual values in the source database. Data certification may verify compliance with data quality standards, help in adding additional interfaces (either internal or external, e.g., Twitter), ensure data completeness, data timeliness and accuracy, and support data quality metrics.

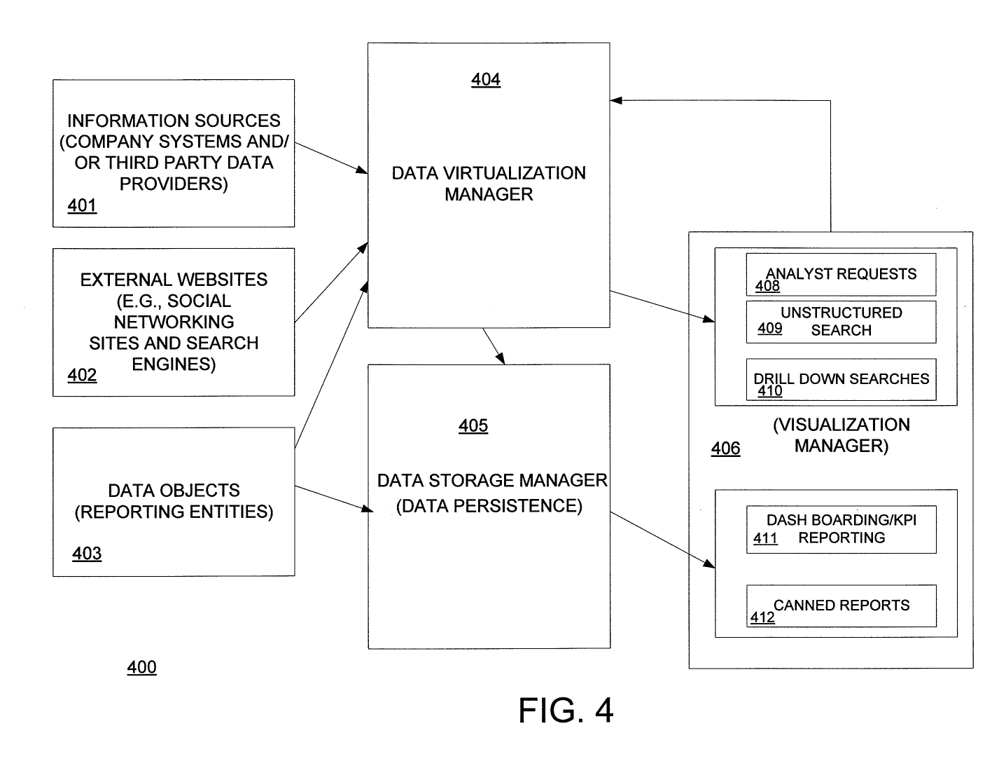

FIG. 4 shows block diagram 400 for system 300 shown in FIG. 3 in accordance with various aspects of the disclosure. Data virtualization manager 404, based on the user file, may access selected data sources from a plurality of data sources by directly tapping into the data sources, including information sources 401, data objects 403 that may be associated with systems of record, and external websites 402. External websites 402 may include social networking sites (e.g., Facebook, Twitter, MySpace, Linkln, and Bebo) and search engines (e.g., Google and Yahoo). Data virtualization manager 404 may determine the accessed data sources as well as the data that is accessed from a particular data source based on the user profile. For example, the user may be a member of one of the business groups (e.g., mortgage group or a credit card group in a financial institution). Data visualization manager 404 obtains a subset of the data from the designated data sources based on the user profile and creates a dataset from the subset. The dataset may then be processed by visualization manager 406 to provide a report as previously discussed.

Data may be accessed “on the fly” and/or stored in a memory device (e.g., a virtual memory or computing cloud) through data storage manager 405, which may be responsible for data persistence when the data is stored. While data storage manager 405 may store data into virtual memory, which may not map to a physical asset, data storage manager 405 may also store data in a data warehouse (not explicitly shown in FIG. 4), for example, on a periodic or scheduled basis.

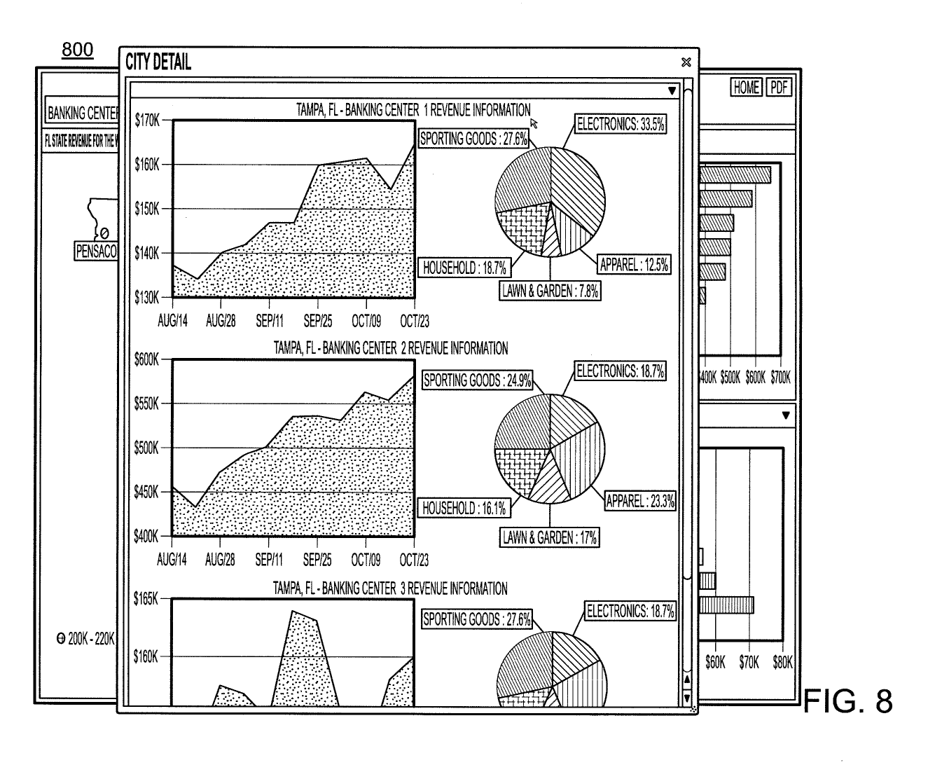

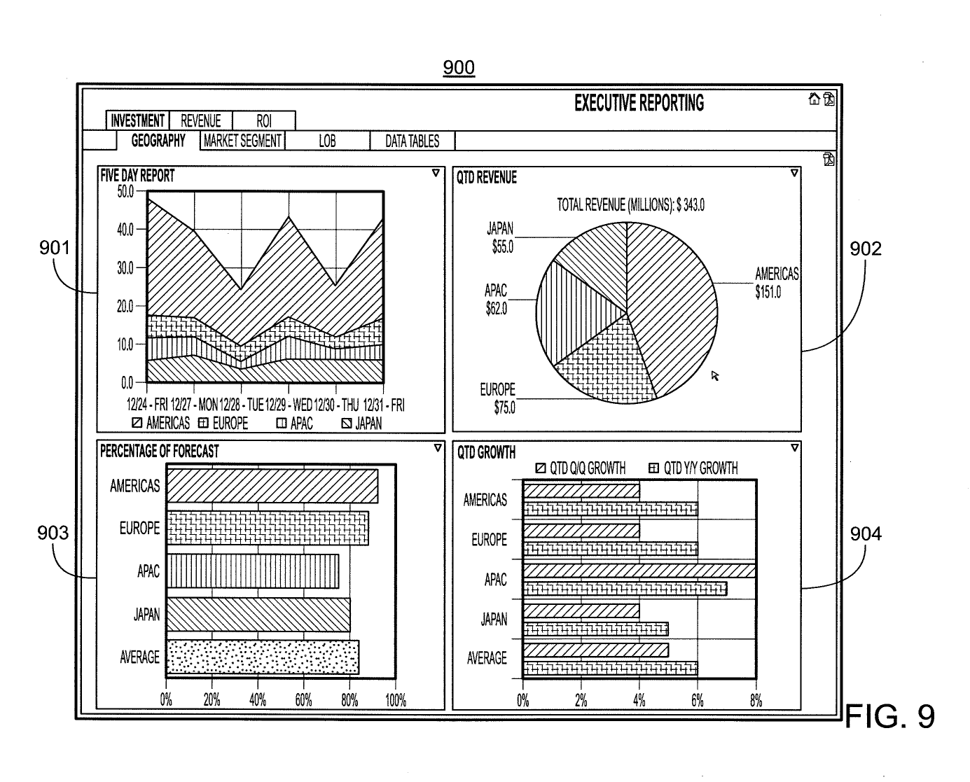

With some embodiments, visualization manager 406 may include analyze requests module 408, unstructured search module 409, and drill down searches 410. For example, unstructured search module 409 may search audio or text messages from one the designated data sources for a particular customer. While not explicitly shown in FIG. 4, but shown as analytics subsystem 303 in FIG. 4, the unstructured data may be analyzed to analyze a customer attribute (e.g., customer satisfaction with the service provided by the business) and to determine a corresponding score. Also, visualization manager 406 may access additional data from data sources through data virtualization manager 404 when more detailed is requested by the user. For example, a user may desire additional information about specific business locations (as illustrated by screenshot 800 in FIG. 8) after viewing am overall marketing summary (as illustrated by screenshot 700 in FIG. 9).

With some embodiments, visualization manager 406 may provide dash board reports and key performance reports through module 411 and canned reports through module 412.

With some embodiments, visualization manager 406 may support different channel for data consumption. For example, processed data may be present to the user on a personal computer, wireless telephone, or computing tablet based on the user's profile. In such a case, visualization manager 406 may filter and/or adjust the presented data to be accommodated on the user's display device.

FIG. 5 shows process 500 for accessing data from different data sources based in a user profile in accordance with various aspects of the disclosure. At block 501, the profile of the user is obtained. The user profile may include the employee identification number, which may be mapped to the business's hierarchy and the employee's functional responsibility. For example, an employee in one business group or affiliate may be restricted by regulatory requirements from sharing information with other business groups or affiliates. For example, the user's employee identification may be mapped to the business group.

At block 502, process 500 then may retrieve data from selected data sources based on the user's profile. For example, credit card information may not accessible to a member of the mortgage lending group because of privacy and regulatory requirements. Data virtualization manager 404 may then access a subset of data from the systems of record (e.g., data sources 401 and 403) based on the user's profile. The subset of data may be obtained by determining one or more data sources from the systems of record as well as selecting pertinent data from the determined data sources.

At block 503 the retrieved subset of data may be validated and transformed. For example, data may be compared with other data or may be analyzed with respect to a set of business rules to ascertain consistency. Moreover, the set of business rules may be static or may be dynamic with respect to time. For example, the policy of fee waivers for a checking may change if a bank wishes to initiate a marketing campaign tying credit card accounts to checking accounts of a customer. Also, data may be transformed, e.g., summing data across all accounts of a banking location and normalizing the sum to the sum over all banking locations.

At block 504, the data may be analyzed, for example, as discussed with analytics sub-system 303 as shown in FIG. 3. For example, data may be associated with other data so that a graph may be constructed for the user. Also, unstructured data may be processed to detect keywords, tone, and level of grammar of text or/and audio files to assess customer satisfaction with the business.

At block 505, the data is presented to the user via the user's designated communications channel. Data may be presented in a variety of ways, including a summary format (as illustrated in FIG. 7 and FIG. 9), a drilled down format (as illustrated in FIG. 8), and dashboard format (as illustrated in FIGS. 10 and 12). Some embodiments may support other presentation formats for customization, collaboration, and sales campaigns. For example, a presentation about a sales campaign may include sales information and response rate for different segments of the corresponding population. Also, presentations may be saved in memory for later access by the user or another user.

FIG. 6 shows process 600 for determining an action based on a determined score of accessed data in accordance with an aspect of the disclosure. The access of data from selected data sources at block 602 may be initiated for different reasons, e.g., verification of a customer during a business transaction at block 601. For example, during a business transaction, different social networking sites may be accessed for the verified customer to determine an attribute and/or characteristic of the customer at block 602. Continuing the example, the customer may post favorable or unfavorable comments about the business. A corresponding score may then be determined based on keywords and/or grammar at block 604. If the score (for example, which may vary from 0 to 100 in an increasing order of customer satisfaction) exceeds a predetermined threshold as determined at block 604, appropriate action may be initiated at block 605. For example, based on derogatory comments about the business, the manager may be alerted during the business transaction so that the manager may personally greet the customer. As another example, if the customer has a large following with Twitter, the business may provide some incentive to the customer because the customer may have an influence over a large group of people.

FIG. 7 shows exemplary screenshot 700 of a consumer marketing summary for a bank in accordance with an aspect of the disclosure. Map 701 shows the revenue per state while bar charts 702 and 703 show the revenues for the ten highest and ten lowest banking centers, respectively. If the user wants specific detail that is not provided by screenshot 700, the user may drill down into the data to get finer and finer detail. (If so, visualization manager 406 as shown in FIG. 4 may send a data request to data virtualization manager 404.) Continuing the example shown in FIG. 7, the user may drill down based on different specifications, e.g., by state, city, segment, zip code, business location (as illustrated by screenshot 800 in FIG. 8), or particular customer.

FIG. 9 shows exemplary screenshot 900 for an executive report for data summarized in FIG. 7 in accordance with an aspect of the disclosure. Graph 901, pie chart 902, bar chart 903, and bar chart 904 show the five day revenue, total, forecasted revenue, and quarterly growth per region, respectively.

FIG. 10 shows exemplary screenshot 1000 of a marketing segment dashboard for data summarized in FIG. 7 in accordance with an aspect of the disclosure. Pie chart 1001, bar chart 1002, bar chart 1003, and pie chart 1004 show the gender, income, marital, and age demographics, respectively.

FIG. 11 shows exemplary screenshot 1100 for configuring the notification to a user when a score of accessed data exceeds a predetermined threshold in accordance with an aspect of the disclosure. For example, when a score exceeds a predetermined threshold as shown in FIG. 6, block 605 may determine that a user should be notified based on the notification configuration. As exemplified in screenshot 1100, the predetermined threshold for the score may be configured by entry 1101. Also, the communications channel (i.e., an e-mail message) may be configured by entry 1102.

FIG. 12 shows exemplary screenshot 1200 of a customized dashboard in accordance with an aspect of the disclosure. Display regions 1201, 1203, and 1205 show sales information for the past twelve months. Also, regions 1202, 1204, and 1206 show the top eight customers in the quarter, sales per company, and actual/pipeline sales, respectively.

Aspects of the embodiments have been described in terms of illustrative embodiments thereof. Numerous other embodiments, modifications and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the embodiments. They may determine that the requirements should be applied to third party service providers (e.g., those that maintain records on behalf of the company).

We claim:

1. A computer-assisted method for processing data in an information technology (IT) system of a business, the method comprising:
receiving, by a computer system, a data request;
determining, by the computer system, a level of access based on a user profile associated with the data request;
in response to the determining, selecting, by the computer system, designated data sources from a plurality of data sources based on the level of access;
retrieving, by the computer system, a subset of the data from the designated data sources;
creating, by the computer system, a dataset for the data request from the subset; and
presenting, by the computer system, the dataset to a display.

2. The method of claim 1, further comprising:
storing the created dataset in a virtual memory.

3. The memory of claim 2, wherein the virtual memory is contained in a computing cloud.

4. The method of claim 1, wherein the presenting comprises:
analyzing the subset of data based on the user profile; and
reporting the analyzed data in a presentation format based on the user profile.

5. The method of claim 1, wherein the presenting comprises:
determining a score for a specified attribute of a business customer; and
when the score exceeds a predetermined threshold, generating an indication for a user action.

6. The method of claim 1, further comprising:
determining a number of followers of a business customer for a social networking site; and
when the number exceeds a predetermined threshold, providing a customer offer to the business customer.

7. The method of claim 1, further comprising:
verifying a customer of the business during a transaction;
in response to the customer verification, querying a server whether there is at least one comment by the customer about the business; and
when accessed data in response to the querying exceeds a predetermined threshold, initiating an action that involves the customer.

8. The method of claim 7, wherein the server includes a social networking website.

9. The method of claim 7, wherein the generating comprises:
providing an incentive by the business to the customer.

10. The method of claim 1, further comprising:
receiving unstructured data from one of the plurality of data sources;
determining a score from the unstructured data; and
when the score exceeds a predetermined threshold, initiating a user action.

11. The method of claim 1, further comprising:
in response to the presenting, obtaining additional data from one of the designated data sources; and
updating the presented dataset.

12. The method of claim 1, further comprising:
analyzing the subset of data to assess an effectiveness of a marketing campaign.

13. An apparatus comprising:
at least one memory; and
at least one processor coupled to the at least one memory and configured to perform, based on instructions stored in the at least one memory:
determining a level of access from a user profile;
obtaining a subset of the data from a plurality of data sources based on the level of access;
creating a dataset from the subset;
determining a score for a specified attribute of a business customer from the dataset; and
when the score exceeds a predetermined threshold, initiating a user action.

14. The apparatus of claim 13 wherein the at least one processor is further configured to perform:
selecting, by the computer system, designated data sources from a plurality of data sources based on the level of access.

15. The apparatus of claim 13 wherein the at least one processor is further configured to perform:
storing the created dataset in a virtual memory.

16. The apparatus of claim 13 wherein the at least one processor is further configured to perform:
analyzing the subset of data based on the user profile; and
reporting the analyzed data in a presentation format based on the user profile.

17. The apparatus of claim 13 wherein the at least one processor is further configured to perform:
determining the score from information obtained from a social networking site.

18. A non-transitory computer-readable storage medium storing computer-executable instructions that, when executed, cause a processor to perform a method comprising:
determining a level of access from a profile of the user that requests data;
in response to the determining, selecting designated data sources from a plurality of data sources based on the level of access of the user;
obtaining a subset of the data from the designated data sources;
creating a dataset for the user from the analyzed subset; and
presenting the dataset in a presentation format to the user, wherein the presentation format is based on the profile of the user.

19. The computer-readable medium of claim 18, said method further comprising:
storing the created dataset in a virtual memory.

20. The computer-readable medium of claim 18, said method further comprising:
determining a score for a specified attribute of a business customer; and
when the score exceeds a predetermined threshold, generating an indication for a user action.

21. The computer-readable medium of claim 20, said method further comprising:
accessing information from a social networking site about the business customer; and
determining the score from the information.

22. The computer-readable medium of claim 20, said method further comprising:
receiving unstructured data from one of the designated data sources; and
determining the score from the unstructured data.

23. The method of claim 1, wherein the plurality of data sources include at least one domain server that resides in a line of business (LOB) domain.
